(19) United States
(12) Patent Application Publication
(10) Pub. No.: US 2021/0252893 A1
(43) Pub. Date: Aug. 19, 2021

(54) PRINTING PROCESSES FOR FINISHED AND SEMI-FINISHED LEATHER GOODS

(71) Applicant: C. Bryan Kloster, Annandale, VA (US)

(72) Inventor: C. Bryan Kloster, Annandale, VA (US)

(21) Appl. No.: 16/793,929

(22) Filed: Feb. 18, 2020

(51) Int. Cl. B41M 5/00

(52) U.S. Cl. CPC B41M 5/0076

(57) ABSTRACT

Printing methods for preconstructed leather goods are disclosed that include printing an art template across the junction of adjacent or adjoining leather panels.

### FIELD OF THE INVENTION

The invention relates to a system and method for printing finished and semi-finished leather goods.

### BACKGROUND OF THE INVENTION

Various printing methods and systems are known in the art. In addition, some printing processes have been used to print on leather hides, which may then be further cut and processed into goods.

### SUMMARY OF THE INVENTION

The present invention includes a method for printing upon a preconstructed leather good. In an exemplary embodiment, the process includes printing an art template across the junction of one or more adjacent or adjoining leather panels of the preconstructed leather good.

### BRIEF DESCRIPTION OF THE DRAWINGS

Further features and advantages of the invention are evident from the following description of preferred embodiment examples of the invention, on the basis of the figures and drawings illustrating details essential to the invention, and from the claims. The individual features can be implemented individually or in any desired combination in a preferred embodiment of the invention.

Preferred embodiment examples of the invention are explained in more detail below on the basis of the enclosed drawings.

FIG. 1 shows an exemplary art template pursuant to an embodiment of the present invention;

FIG. 2A shows a portion of a belt that may be printed pursuant to an embodiment of the invention;

FIG. 2B shows a section view of the belt portion of FIG. 2A along the line A-A;

FIG. 2C shows an exemplary art template pursuant to an embodiment of the present invention;

FIG. 3A shows an exemplary art template for a belt having a first size pursuant to an embodiment of the present invention;

FIG. 3B shows an exemplary art template for a belt having a second size pursuant to an embodiment of the present invention;

FIG. 3C shows an exemplary alternative art template for a belt having a second size pursuant to an embodiment of the present invention;

FIG. 4A shows an exemplary embodiment of a jig pursuant to an embodiment of the present invention;

FIG. 4B shows an exemplary embodiment of an opening in a jig pursuant to an embodiment of the present invention;

FIG. 4C shows an exemplary alternative embodiment of an opening in a jig pursuant to an embodiment of the present invention;

FIG. 5A illustrates an exemplary embodiment of preparing a jig by printing an art template onto it pursuant to an embodiment of the present invention;

FIG. 5B shows an exemplary embodiment of a jig with an opening pursuant to an embodiment of the present invention;

FIGS. 6A-6C show alternative exemplary embodiments of a jig pursuant to certain embodiments of the present invention;

FIG. 7 illustrates an exemplary suction table system that may be utilized pursuant to certain embodiments of the present invention;

FIG. 8 illustrates a jig with a preconstructed leather good positioned on a suction table and in proximity to a printer and controller pursuant to certain embodiments of the present invention;

FIG. 9A shows exemplary art templates for a belt and a belt component pursuant to an embodiment of the present invention;

FIG. 9B shows an exemplary belt blank pursuant to an embodiment of the present invention;

FIG. 9C shows a section view of the belt blank of FIG. 9B;

FIG. 9D shows a schematic view of the belt blank of FIG. 9B and a belt component positioned in a jig;

FIG. 9E shows an exemplary printed belt pursuant to an embodiment of the present invention;

FIGS. 10A and 10B show exemplary art templates for a credit card holder pursuant to an embodiment of the present invention;

FIG. 10C shows an exemplary credit card holder for printing pursuant to an embodiment of the present invention;

FIG. 10D shows a schematic side view of the credit card holder of FIG. 10C;

FIG. 10E shows an exemplary leather layer configuration of the credit card holder of FIG. 10C pursuant to an embodiment of the present invention;

FIG. 10F shows a schematic view of the credit card holder of FIG. 1C positioned in a jig; and

FIGS. 10G and 10H show a printed credit card holder pursuant to an embodiment of the present invention.

FIG. 11A shows an exemplary art template pursuant to an embodiment of the present invention;

FIG. 11B shows an exemplary portfolio that may be printing pursuant to an embodiment of the invention;

FIG. 11C shows the exemplary portfolio of FIG. 11B as printed pursuant to an embodiment of the invention;

FIG. 12A shows an exemplary portfolio printed pursuant to an embodiment of the invention;

FIG. 12B shows an exemplary art template pursuant to an embodiment of the invention;

FIG. 12C shows the exemplary portfolio of FIG. 12A as further printed pursuant to an embodiment of the invention;

FIG. 13A shows an exemplary art template pursuant to an embodiment of the present invention;

FIG. 13B shows an exemplary zippered portfolio printed pursuant to an embodiment of the invention;

FIGS. 14A-14B show exemplary art templates pursuant to an embodiment of the present invention;

FIGS. 14C-14D show an exemplary portfolio with the art templates of FIGS. 14A-14B printed on respective portions of the portfolio pursuant to an embodiment of the present invention;

FIG. 15A shows an exemplary art template pursuant to an embodiment of the present invention;

FIG. 15B shows an exemplary leather bag printed pursuant to an embodiment of the invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention but does not limit the scope or substance of the invention.

As used herein, term “preconstructed leather good” means a finished leather good and/or a semi-finished leather good. As used herein, “finished leather good” means a leather product that has been constructed or assembled into its final construction such that it is ready for wear or use and does not require further processing after printing. As used herein, “semi-finished leather good” means a leather product that requires some additional assembly steps to become a finished good, such as the attachment of component parts or pieces after printing, but does not require any additional cutting, forming, or treating of the leather itself. By way of example, the leather strap of a belt and any backing materials may be a semi-finished leather good if the leather strap requires the attachment of a belt buckle after printing. In some embodiments, a finished leather good and a semi-finished leather good may include two components, such as two distinct leather components, that are joined together, such as by a seam, to form a semi-finished leather good or a finished leather good. Notably, preconstructed leather goods may include additional materials than leather as further illustrated by the examples herein. In addition, in some embodiments, a finished leather good and a semi-finished leather good may be configurable in a generally flat position. As used herein, neither a finished leather good nor a semi-finished leather good requires or permits any additional cutting of the leather after the inventive printing process disclosed herein. For example, a leather hide that is printed and then cut and/or formed into one or more leather products after printing is not a finished good or a semi-finished good in the context of this disclosure.

As used herein, “preconstructed white leather good” means either a finished article or a semi-finished article wherein the leather surface(s) to be printed using an embodiment of the present invention consist of white leather. Any processes or embodiments disclosed herein concerning a preconstructed leather good may include a preconstructed white leather good.

In an exemplary embodiment, a method of the present invention specifically includes printing on a preconstructed leather good. In some embodiments, methods of the present invention include printing on a preconstructed white leather good that is or may be configured in a generally flat configuration at the printing stage. In some specific embodiments, methods of the present invention include printing on a preconstructed leather good, such as a preconstructed white leather good, such as a pre-constructed credit card case or belt. In other embodiments, preconstructed leather goods that are made with non-white leather may be printed directly with any designs or may be first printed in a first pass with a white color on the preconstructed leather good, which then may be printed with other colors in a second pass. In all embodiments, the leather of the preconstructed leather good, or at least any leather surface thereof to be printed, may optionally have been treated to remove any layers of polish, oils, or other substances remaining from the tanning and/or dying process.

In some embodiments, the preconstructed leather good, or a leather surface thereof to be printed, may be approximately uniform in thickness. As used herein, such approximately uniform thickness does not preclude some minor deviations in thickness due to the natural contour of leather, but it does preclude the more significant deviations that may be found in an entire hide of leather as compared with a finished good or semi-finished good. By way of illustration, some hides of leather may generally have thickness variations on the order of 0.2 millimeters. By contrast, in some embodiments of the present invention, the leather portion of a preconstructed leather good will have a thickness variability of less than 0.2 millimeters or, ins some embodiments, approximately no appreciable thickness variability for printing, which may in some embodiments result from a skiving process being performed on the leather prior to construction of the preconstructed leather good in order to obtain a uniform thickness.

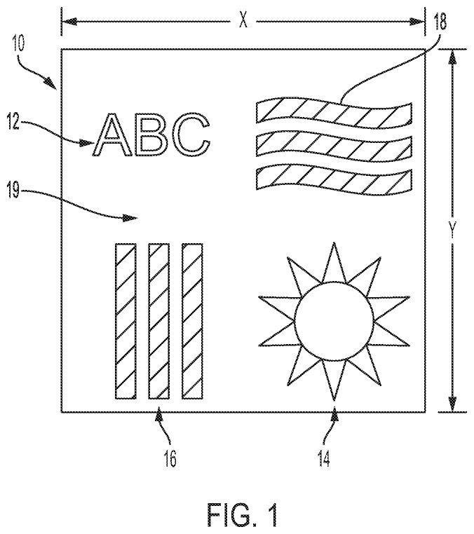

According to an embodiment of the invention, an art template for printing on the leather good may be prepared and stored. The art template may be prepared manually and loaded into a computer system, such as by scanning, or created by using any suitable graphic design program, such as Adobe Illustrator available from Adobe Inc. The art template may include any desirable indicia for printing, including text, designs, shapes, art, graphics, symbols, logos, patterns, combinations thereof, and any other printable matter. An art template may also utilize colors, unprinted portions, and any other printing techniques. By way of example, FIG. 1 shows an art template 10 having dimensions X and Y and including font 12, graphic 14, first pattern 16, second pattern 18, and unprinted portions 19.

In some embodiments, an art template may be designed for a specific type of preconstructed leather good by taking into account the shape and dimensions of that preconstructed leather good or a portion thereof to be printed. For example, dimensions X and Y of art template 10 may correspond to the size of a preconstructed leather good, such as a credit card holder. In some embodiments, an art template may include a design for printing on a preconstructed leather good or a portion, such as shown with art template 10 in FIG. 1. In some embodiments, an art template may include a design that may be printed on an entirety of a leather good, such as an art template including a color that covers all portions of a preconstructed leather good, such that the final preconstructed leather good appears to have that overall leather color. In still other embodiments, an art template may provide for a color to be printed on all portions where no other indicate are printed, such that the preconstructed leather good appears to be of that printed color. Where art templates utilize unprinted portions of a preconstructed leather good, the underlying leather, which may be white leather, remains unprinted.

In some embodiments of the present invention, a preconstructed leather good may have some pre-existing features prior to printing, such as a sewn or branded leather portions, an opening or hole, attached components, or other features. Such features may be considered in the art template, such as whether they are to be printed or to remain unprinted during the printing process. In some embodiments, an art template may be configured such that no printing occurs on any features of the preconstructed leather good that have a substantially raised portion from the surface of the remainder of that surface to be printed of the preconstructed leather good, such as an embroidered portion. In addition, some preconstructed leather goods may have multiple panels (including layered panels), portions, layers, segments, stitchings, and/or seams, and art templates may be utilized such that the printing processes of the present invention may include, target, or exclude printing on such portions in using the printing processes described herein. As used herein, the term “panel” shall mean a distinct cut portion of leather that may be joined with or positioned adjacent to one or more other panels (i.e., distinct cut portions of leather) in a preconstructed leather good, such as by stiches, seams, or adhesive.

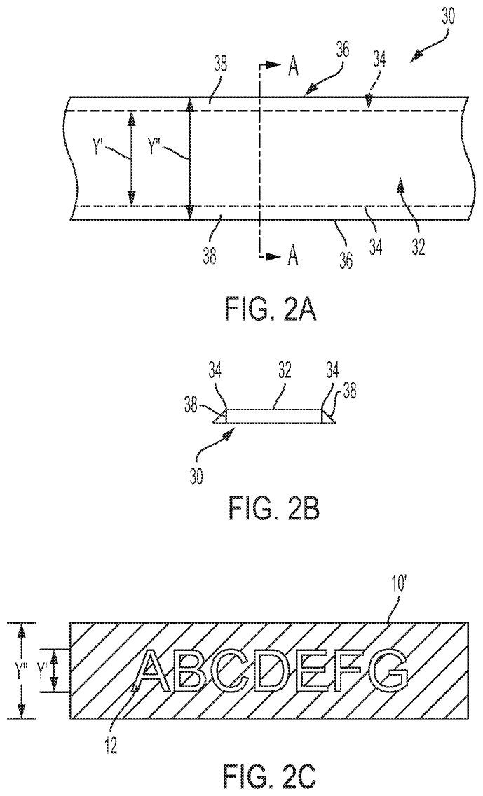

As indicated above, in some embodiments an art template may have printing dimensions that are the same or about the same size as the upper surface of the preconstructed leather good to be printed. In other embodiments, an art template may be configured such that it is larger in one or more dimensions than a portion of the preconstructed leather good upon which it will be printed. For example, FIGS. 2A and 2B show portions of a belt 30 having a face 32, stitchings 34, edges 36, and beveled portions 38 between each stitching 34 and edge 36. As shown in FIG. 2C, art template 10′ may have printed text in a region of width Y′ to print on belt face 32, but art template may include background color (shown as cross-hatching) that will be printed onto all otherwise unprinted portions of the entire exterior leather facing of the belt, including beveled portions 38. For example, such background color may not be printed at portions where other design indicia or text are printed but may be printed at all other exterior portions of belt 30 (such as face 32, stitchings 34, and beveled portions 38). In this example, art template 10′ may be designed to have a width equal Y″. By contrast, for embodiments in which only printing in face 32 is desired, an art template may have a width of Y′. In other embodiments, the text may span the width Y″ on a belt. In still other embodiments, a single art template may be prepared based on the dimensions of an entire jig, which is described in detail below, and the position of multiple preconstructed leather goods therein such that all such preconstructed leather goods in a jig may be printed in a single pass by an ultraviolet printer based on a single art template for that entire jig.

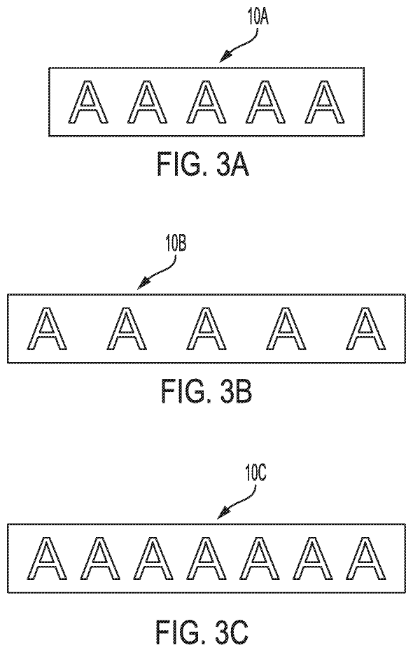

In addition, in some embodiments, an art template may be adjusted for different sized preconstructed leather goods. For example, an art template that is used for printing on a leather belt may be adjusted for belts of a different size. In some embodiments, an art template may be scaled to print upon both a 32″ belt and a 42″ belt, either by proportionally spacing the design over the larger surface area or by adding additional design elements. For example, as shown in FIG. 3A, art template 10A is shown for a 32″ belt 30 having five A characters. Art template 10A may be scaled for a larger 42″ belt either by proportionally spacing the five A characters, as shown by art template 10B in FIG. 3B, or by adding additional A characters, as shown by art template 10C in FIG. 3C. In still other embodiments, a separate art template may be prepared for each distinctly-sized or distinctly-shaped preconstructed leather good.

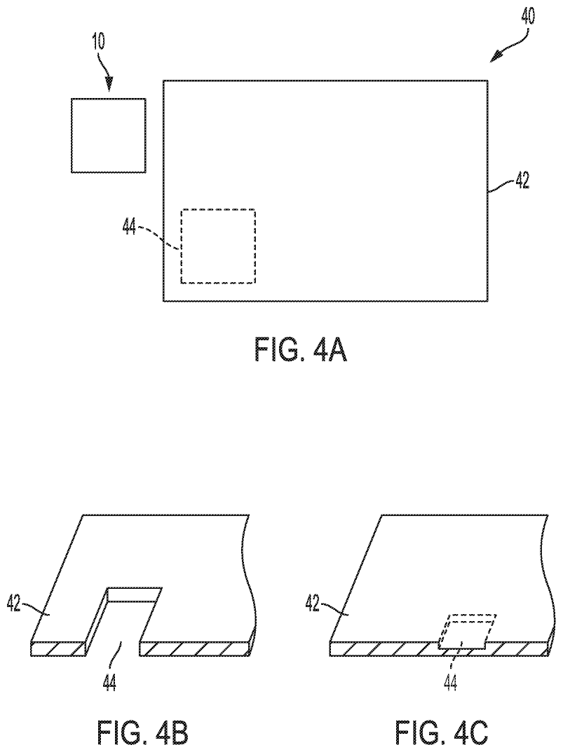

The present invention includes processes for printing art templates onto a leather good. In some embodiments, a jig may be used such as to position or secure a preconstructed leather good during the printing processes. By way of example, FIG. 4A shows a jig 40 that is constructed of a flat, board-like material 42 and includes opening 44. A jig may be configured with a single opening or multiple openings (either of the same or different sizes and/or shapes). In some embodiments, opening 44 may be the same or approximately the same size as a preconstructed leather good to be printed or a portion thereof. In still other embodiments, opening 44 may be sized to correspond or to approximately correspond to the art template 10 to be printed on the leather good.

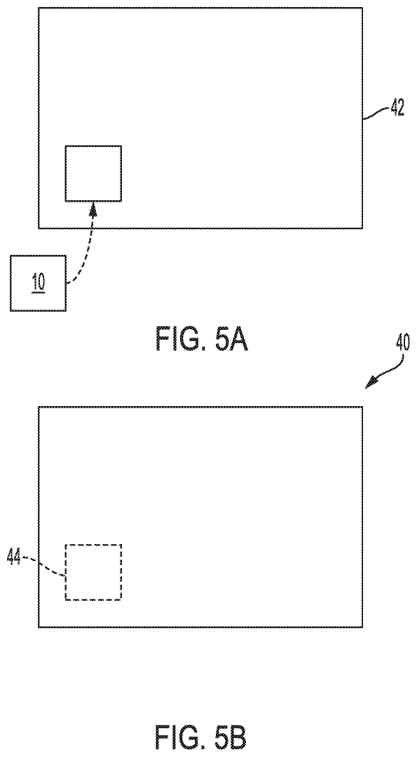

As shown in FIG. 5A, jig 40 may be prepared by printing an art template (such as art template 10), which may be configured to have the same size or approximately the same size as the surface of a leather good to be printed, directly onto board 42. The printed portion may then be removed, such as by cutting, to form jig 40 having opening 44 as shown in FIG. 5B. In some embodiments, the entire thickness of board 42 may be cut to remove the portion corresponding to the size of the printed art template, such as shown in FIG. 4B. In other embodiments, less than the entire depth of board 42 may be cut and removed, such as to create an opening of the type shown in FIG. 4C.

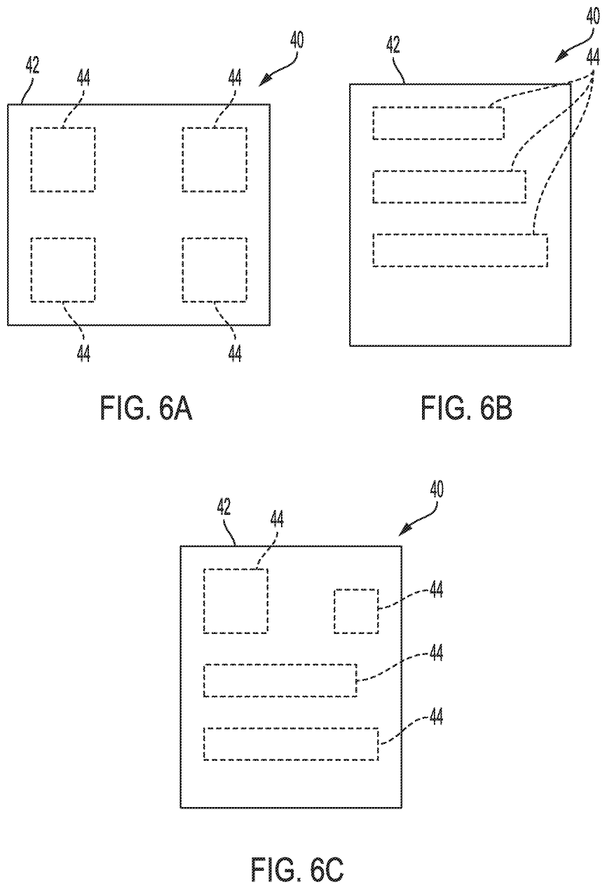

It may be desirable in some embodiments to print multiples sizes of a preconstructed leather good, such as different-sized belts, or to print different preconstructed leather goods, such as both belts and credit card holders, during a single printing process. In such embodiments, such as shown in FIGS. 6A, 6B, and 6C, a jig having multiple openings with one or more distinct sizes may be employed based on the leather goods to be printed. For example, as shown in FIG. 6A, jig 40 may have multiple openings 44 of the same size, such as for printing more than one of the same leather good in a printing process. As shown in FIG. 6B, jig 40 may have multiple openings 44 of the same shape but of different sizes, such as for printing leather goods having different lengths and/or widths in the same printing process. In addition, as shown in FIG. 6C, a jig 40 may have openings 44 of different sizes and shapes for printing different leather goods and/or different sized leather goods in a printing process. As noted above, an art template may be prepared for an entire jig wherein any printed portions are calibrated to the positioning of a particular preconstructed leather good within the jig.

A jig used in printing processes of the present invention may be constructed of any suitable material, such as boards made of moderately expanded closed-cell polyvinyl chloride as available, for example, from 3A Composites USA under the trade name Sintra. In addition, a jig may be any suitable size for a contemplated printing process. By way of example, in some embodiments, a jig may be six feet wide and have a thickness of one-eighth of an inch. Alternate sizes may be utilized depending on the size and quantity of items to be printed in a particular printing process.

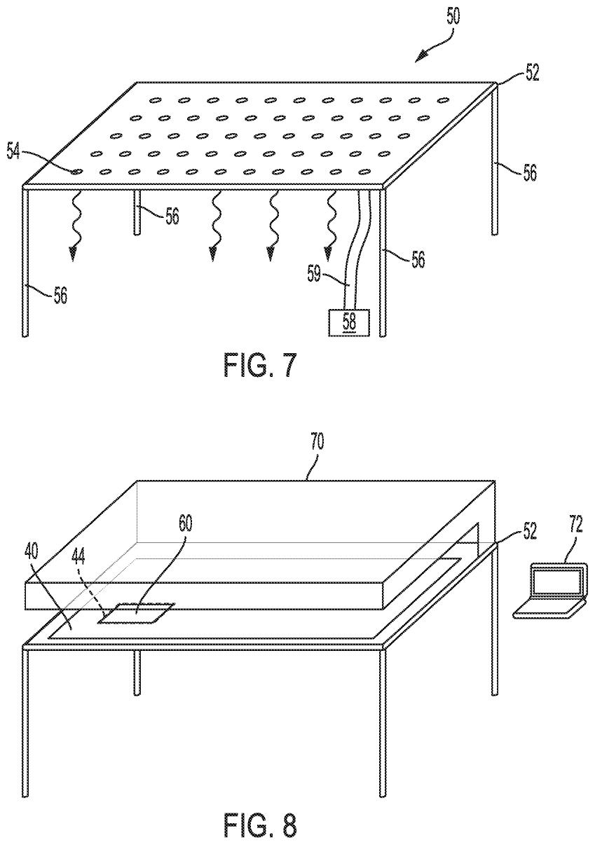

A jig may be secured to a table or any suitable surface upon which the printing will take place by any suitable means, such as adhesive, or tape. In some embodiments, a jig may be secured upon a suction table, such as suction table 50 shown in FIG. 7. As shown, suction table 50 includes surface 52 having a plurality of holes 54 and legs 56. Suction table 50 may include a suction device 58, such as an aspirator or vacuum device, that is connected to suction table 50 by tubing 59 and operates to create a downward suction force through holes 54 as shown by the arrows in FIG. 7. In some embodiments, a jig may be secured to any suitable surface or a suction table by multiple securing means.

A preconstructed leather good may be placed within an opening of a jig for printing. For example, as shown in FIG. 8, preconstructed leather good 60 has been placed within opening 44 of jig 40, which is secured to table surface 52. As shown, preconstructed leather good 60 is in a generally flat arrangement and has the same length and width as opening 44. In some embodiments, a preconstructed leather good may be further secured, such as by adhesive. The printing software used in a particular application may be calibrated such that the jig is aligned with the art template to be printed.

As also shown in FIG. 8, ultraviolet printer 70 may be positioned and configured such that its print head will print onto a preconstructed leather good to be printed. In some embodiments, the printer may have a vertically-adjustable print head to accommodate printing on leather goods having different thicknesses. In such embodiments, the print head may be positioned for printing on a particular preconstructed leather good based on the height/thickness of the preconstructed leather good at its highest point when positioned flat on the table. In addition, ultraviolet printer 70 may be in communication, such as by wired connection or wireless connection, with a control device, such as computer 72, which may include a processor, a memory, and a graphic user interface.

Prior to commencing printing, an art template may be loaded into the memory of a computer that is in communication with a printer to be utilized in the printing process. In some embodiments, an art template may be previously transferred and stored into the printer or computer memory in order to utilize it in creating a jig as described above. A computer may also be configured to store in memory and utilize any printing software compatible with the printer being utilized, and an art template for printing may be imported into such software. By way of example, in some embodiments, a Roland LEJ-640 ultraviolet printer may be utilized and connected to a computer configured with Roland VersaWorks software, wherein both the printer and software are available from Roland DGA Corporation. One of ordinary skill in the art will understand that alternative ultraviolet printers and printing software may be readily employed within the scope of the present invention. In addition, any suitable ultraviolet printing inks may be employed in the printing process of the current invention and loaded into the ultraviolet printer. By using an ultraviolet printing processes, the ink may beneficially result in printing within any textured or embossed portions of the preconstructed leather good as the caking and freezing feature provided by the ultraviolet printing process allows for the instantaneous drying of the ink on dynamic surfaces.

The ultraviolet printer may print the art template design onto an exposed surface of the preconstructed leather good or a portion thereof. In some embodiments, which may include some embodiments using a preconstructed white leather good, the printing process will involve a single printing pass. As used herein, the term “single printing pass” means that an art template design is printed on a side of a preconstructed leather good in a single printing operation, whereby all design indicia of the art template are printed in a single pass of the printer, such that a second coat or additional printing is not required. Such single pass printing may improve accuracy in placement and color, replicability, and efficiency in the printing process of a preconstructed leather good.

In some embodiments involving a preconstructed leather good that is not a preconstructed white leather good, printing may be done in a single pass as described above. For example, a brown leather preconstructed leather good may be printed in a single pass as described herein. In other embodiments involving a preconstructed leather good that is not a preconstructed white leather good, a first printing pass may be utilized to print a color, such as white, onto all or a portion of the preconstructed leather good so as to form a background color, and then a second printing pass may be utilized to print other design elements as discussed above using one or more other colors.

In some embodiments, the present invention provides for preconstructed leather good to be printed with pantone colors with improved accuracy and repeatability as compared to some traditional printing processes. For example, by providing single-pass printing on a preconstructed leather good, the color(s) printed on an article are subject to less deviation and variations that may be found in multi-pass printing applications, which accuracy may be further improved when printing on white leather. Such pantone matching is best achieved on white preconstructed leather goods.

In some embodiments, the printing may be applied to one or more portions of a preconstructed leather good. For example, as explained above, an art template may be continuously printed over stitchings in a preconstructed leather good. In addition, an art template may be continuously printed over seams, including raised seams, as well as distinct leather portions or segments of a preconstructed leather good, including distinct layered leather panels such as illustrated in the examples discussed below and without distortion. Likewise, an art template may be continuously printed over a beveled portion of a preconstructed leather good. These various embodiments are further described in the illustrative embodiments discussed below.

Because the present invention contemplates printing upon preconstructed leather goods, a printed preconstructed leather good will not require any further cutting or shaping of the product or leather as would be required if a leather hide were printed and then subsequently manufactured or assembled into products. However, as noted above and described further in the examples below, semi-finished leather goods may require additional finishing steps to form a finished leather good.

By way of further illustration, embodiments of the present invention will be described below in the context of exemplary finished goods and semi-finished goods:

### Exemplary Embodiment of Printing a Belt as a Semi-Finished Good

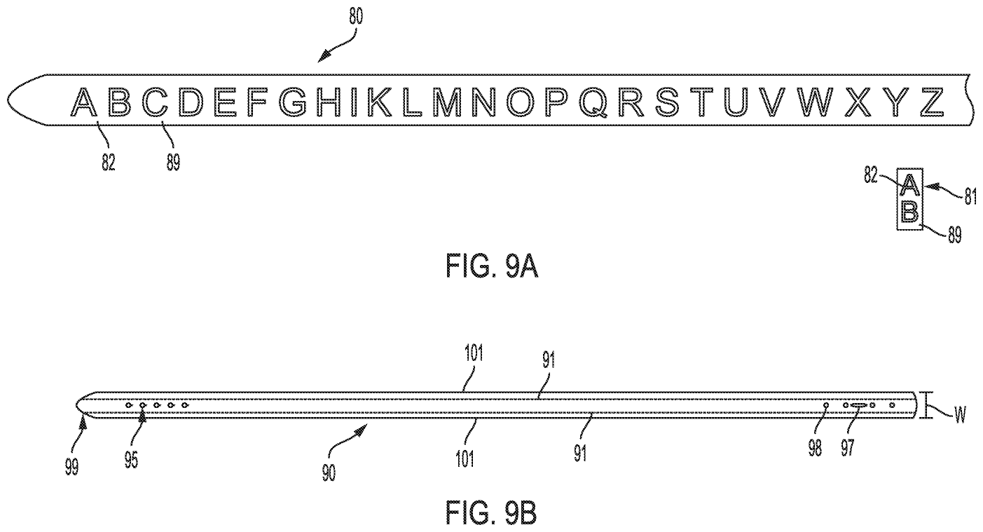

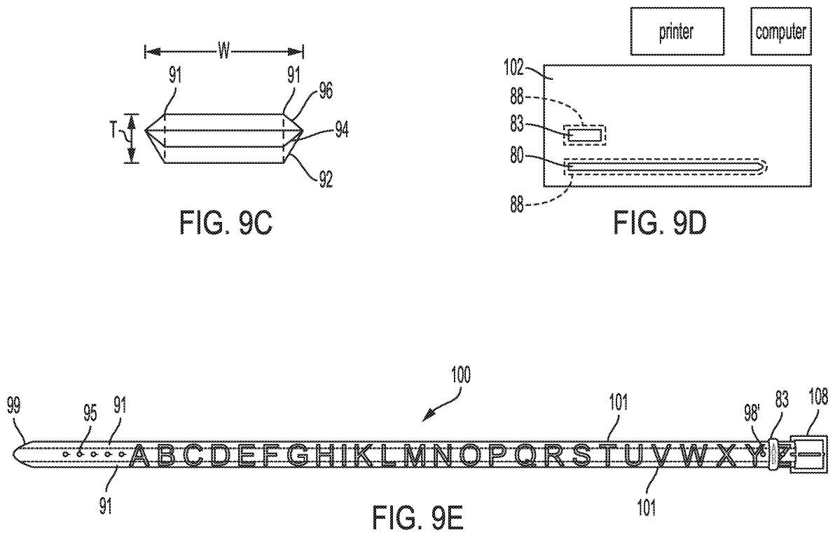

By way of further illustration and with reference to FIGS. 9A-9E, the method of printing will be described wherein a belt is the semi-finished leather good. As shown in FIG. 9A, art template 80 may be created having font 82 and unprinted portions 89 using the processes described above. Art template 80 may be designed accounting for certain features of the preconstructed leather good to be printed. For example, with reference to FIG. 9B, it may be desirable in some embodiments to avoid printing at preformed holes 95 of belt blank 90 in some embodiments, such that those areas are designed without printing marks in art template 80. By contrast, it may be desirable in some embodiments to print designs on certain specific portions, such as shaped tip 99 of belt blank 90, which may be highly visible on a belt wearer and where printing certain features may be desired such that art template 80 includes such desirable aspects for printing on such positions.

Art template 80 also may be configured to correspond with a size of a particular belt, such as a 32″ belt. However, art template 80 may be scaled as described above when printing on different length belts. Any predetermined belt size, such as a 32-inch belt, a 34-inch belt, a 36-inch belt, a 38-inch belt, a 40-inch belt, a 42-inch belt, and any other predetermined belt sizes may be readily employed. In addition, art template 80 may be configured in some embodiments with a size and design to print solely on all or portions of the belt blank surface between stitchings 91, and in other embodiments art template may be art template 80 may be configured with a size to print all or portions of the belt blank surface between edges 101, optionally including printing on stitchings 91.

In this exemplary embodiment, belt blank 90 is shown in FIGS. 9B and 9C. Belt blank 90 has a desired thickness (T) and width (W) of the final belt product. The belt blank is not simply a strap of loose leather but instead is a semi-finished good. As shown, belt blank 90 is comprised of backing leather 92, cork liner 94 (which may be other forms of padding material in other embodiments), and top grain 96 as shown in FIG. 9C. The leather of top grain 96 may have been pretreated to remove any polish, oils, or other substances from the tanning process and, in some specific embodiments, top grain 96 is white leather. Backing leather 92, cork liner 94, and top grain 96 may be joined together in any suitable manner. In some embodiments, stitchings 91 may join together some or all of backing leather 92, a cork liner 94, and top grain 96. In some embodiments, adhesive may alternatively or additionally be used to bind together some or all of the layers of material as shown in FIG. 9C. In addition, with reference to FIG. 9B, belt blank 90 may have performed holes 95, a buckle slot 97, closure snap openings 98, and a shaped tip 99. As a semi-finished leather good, belt blank 90 will not require additional sizing or cutting to form a final belt product after printing.

In some embodiments, other components may also be present and optionally printed. For example, as shown in FIG. 9E, a finished belt 100 may include a keeper 83, through which any remaining belt portion extending beyond the buckle after buckling may be secured. Keeper 83, as well as any other accessory pieces or components, may optionally be printed in the same manner as belt blank 90 by creating an art template 81 for keeper 83 and following the printing processes disclosed herein. In other embodiments, an art template may be utilized for some or all accessary pieces or components, such as art template 81 for keeper 83, or some or all such pieces or components may optionally not be printed.

Belt blank 90 and keeper 83 may be secured in respective openings 88 of jig 102, wherein an opening 88 is sized for belt blank 90 and an opening 88 is sized for keeper 83. Jig 102 is positioned beneath or within ultraviolet printer 70, which is in communication with a computer 72 having art template 80 and art template 81 stored in memory. Art template 80 may then be printed onto belt blank 90, and art template 81 may then be printed onto keeper 83. Any unprinted portions will retain the color of top grain 96. For example, in embodiments employing white leather, any unprinted portions will retain the white leather appearance. The entire printing operation may be completed in a single pass as described above. In other embodiments, belt blanks and keepers may be secured in separate jigs and printed separately. Following printing, buckle 108 may be inserted into the buckle slot 97 and that belt end folded back and secured with closure snaps 98′ in closure openings 98. Keeper 83 may be installed into belt blank 90 to form finished belt 100 as shown in FIG. 9E.

As noted, art templates may be designed to print on desired portions of a preconstructed leather good. In some embodiments, art templates may be utilized to include printing in the area between stitchings 91 and edge 101 of belt blank 90. In such embodiments, as shown in FIGS. 9C and 9E, this area has a different thickness than the area between stitchings 91. Using the methods of the present invention, such printing may be accomplished on articles having multiple thicknesses with good quality on all printed portions.

### Exemplary Embodiment of Printing a Wallet as a Finished Good

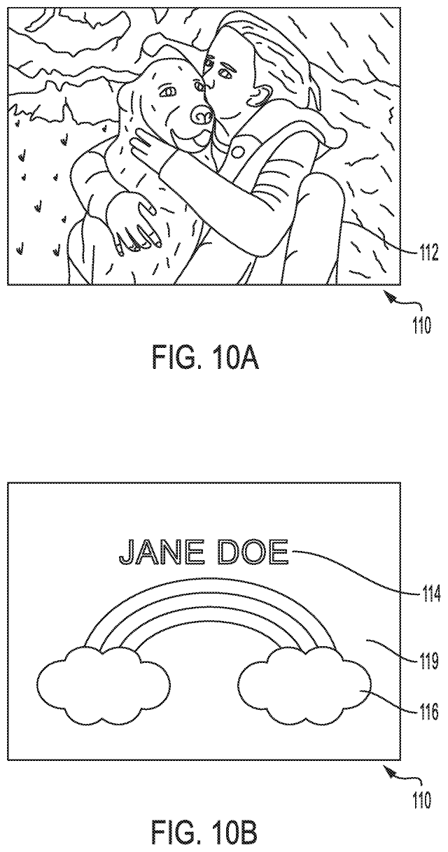

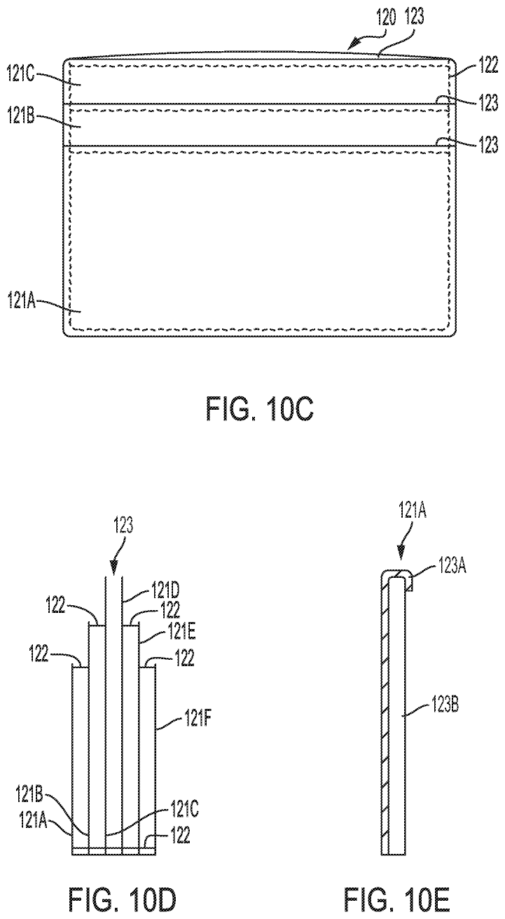

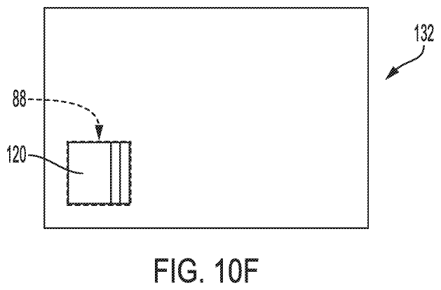

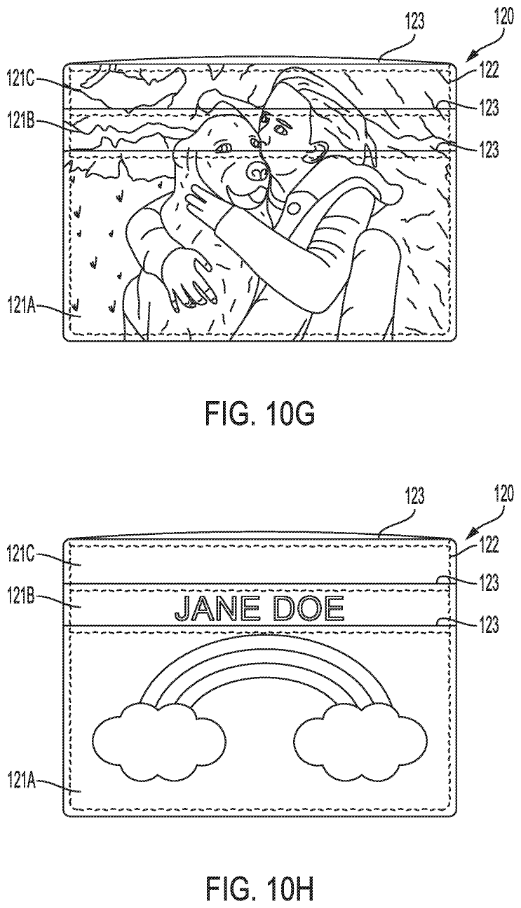

By way of further illustration and with reference to FIGS. 10A-E, the method of printing will be described wherein a credit card holder is a finished leather good printed using an exemplary embodiment of the present invention. As shown in FIGS. 10A and 10B, art template 110 may include a first design for a front surface of a credit card holder and art template 111 a second design for a back surface of the credit card holder. Art template 110 and art template 111 may have one or more of image 112, font 114, design elements 116, and unprinted portions 119 using the processes described above. Notably, art template 110 is designed to print a photograph over an entire surface of a credit card case, including over stitching and different panels, or sections, of leather as further explained below. In addition, as shown, the art templates may be customized or personalized in some embodiments, such as to include a name, initials, corporate branding, advertising material, photography, or any other customized or personalized design.

Art templates 110 and/or art template 111 also may take into account certain features of the leather article to be printed. For example, art template 111 positions the text “JANE DOE” within a distinct portion that will be printed in a section between two leather segments on the credit card holder (as shown in FIG. 10H).

In this exemplary embodiment, credit card holder 120 is a finished good so that no additional processing or finishing is required after printing. A credit card holder may have various compositions and configurations. For example, FIGS. 10C and 10D show credit card holder having two pockets 123 on each side and pocket 123 at the top portion. As shown, credit card holder 120 is formed from six leather layers or panels 121A-F that are joined by stitching 122. Notably, each leather layer 121A-F need not be comprised entirely of leather and some portions, such as interior portions, optionally may be comprised of another material, such as vinyl or fabric. For example, with reference to FIG. 10E, portion 123A of leather layer 121A is comprised of leather and portion 123B is comprised of vinyl. Portion 123A may be joined, such as by adhesion and/or sewing, to portion 123B to form leather layer 123, which is comprised of multiple materials. As shown, portion 123A may fold over portion 123B at a top end such that from an exterior view credit card holder 120 appears to have an overall leather construction. Other leather layers may optionally this same or a similar construction. In addition, in some embodiments, some or all leather layers may be completely leather or substantially leather. In addition, the credit card holder may have any shape desired. For purposes of this example, the wallet is a finished leather good that will not require additional sizing or cutting or any necessary processing after printing

As shown in FIG. 10C, the visible portions of leather layers 121A-F include leather, and that leather may have been pretreated to remove any polish, oils, or other substances remaining from the tanning and/or dying process. In some specific embodiments, such leather is white leather.

As shown in FIG. 10F, credit card holder 120 may be secured in an opening 88 of jig 132 in a generally flat arrangement in jig 132. In some embodiments, adhesive or other suitable means may be used to secure the wallet in a generally flat configuration.

Jig 132 may be positioned beneath or within an ultraviolet printer, as described above, which is in communication with a computer 72 having art template 110 and art template 111 stored in memory. Art template 110 and art template 111 may then be printed onto wallet 120 with a single pass on each side of credit card holder 120. For example, art template 110 may be printed on the first side of credit card holder 120 in a single pass, and then credit card holder 120 may be flipped over in jig 132 and art template 111 may then be printed on the second side of credit card holder 120. In some embodiments employing white leather, any unprinted portions will retain the white leather appearance. As noted above, multi-pass printing may alternatively be employed to print part or all of a side of credit card holder 120 in a first pass, such as by printing a white background color on all or a portion of such side in a first pass, and then in a second pass printing the art template design.

FIGS. 10G and H illustrate respective printed sides of credit card holder 120. As shown in FIG. 10G, the photographic image of art template 110 was printed across an entire surface credit card holder 120, i.e., edge-to-edge printing, including over stitching 122 and distinct leather layers 121A-C. In addition, FIG. 10H illustrates the selective placement of certain design features based on the design of credit card holder 120, such as the “JANE DOE” text located on leather layer 121E between two pockets 123 as designed in art template 111.

The present invention is not limited to credit card holders. Instead, any type of card holder or wallet may be printed using the printing processes described herein. In some embodiments, a wallet may be a finished leather good that is printed, such as a cardholder wallet, a bi-fold wallet, a tri-fold wallet, and a money clip. In other embodiments, a wallet may be a semi-finished leather good, such as a wallet having a keychain (which may be attached after printing) or a wallet with a card holder insert (which may optionally be printed and may be inserted after printing). In addition, some wallets may be a semi-finished leather good that includes snaps, closures, plastic card holders or covers, or other structures that may be installed after printing. Furthermore, a wallet as either a finished leather good or a semi-finished leather good may have components other than leather prior to printing, such as vinyl portions, fabric portions, hook and loop fastener portions, and other materials.

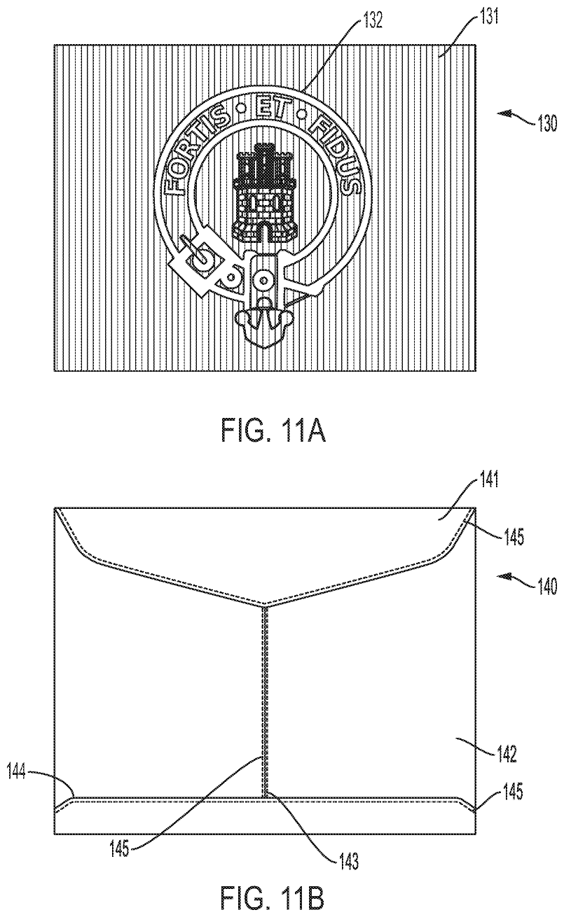

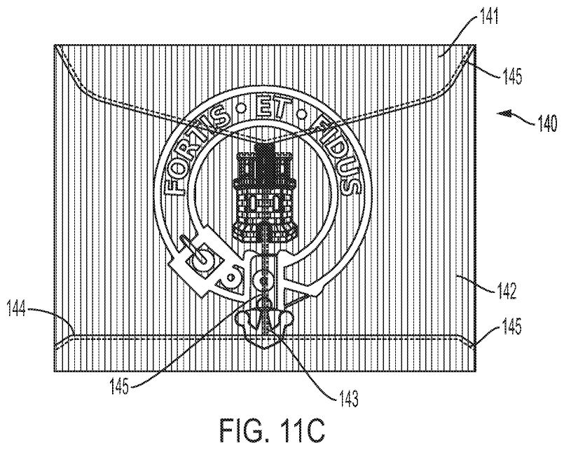

By way of further illustration, FIG. 11A depicts art template 130 having background color 131 and design 132 and FIG. 11B shows portfolio 140 as a preconstructed leather good having flap 141, side 142, seam 143, raised seam 144 (where distinct panels are joined and layered), and stitching 145. As shown, flap 141 and side 142 form distinct and layered leather panels. In addition, raised seam 145 joins distinct leather panels. As illustrated in FIG. 11C, art template 130 having the logo 132 and a background color 131 (shown as cross-hatching) may be continuously printed without distortion onto portfolio 140 in a single pass using the methods of the present invention described herein, including on and across the distinct layered panels noted above and the seams and stitching. If desired, the reverse side of portfolio 140 (not shown) could also be printed with any art template by positioning that side for printing as described herein.

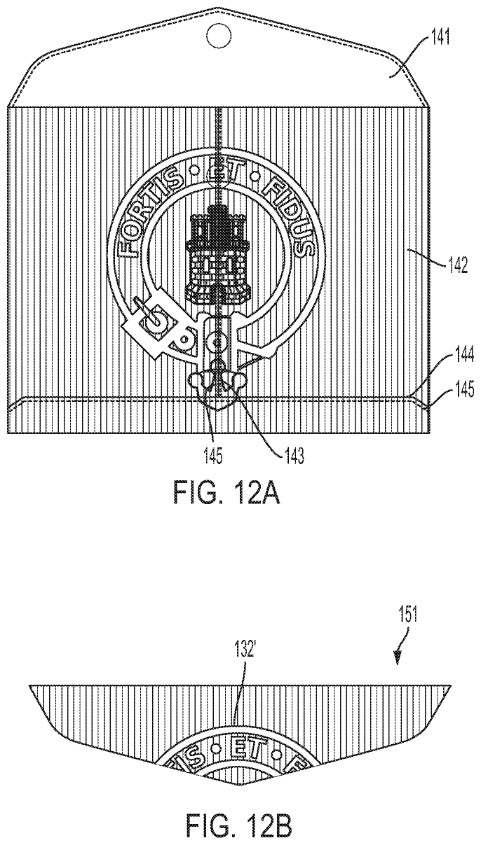

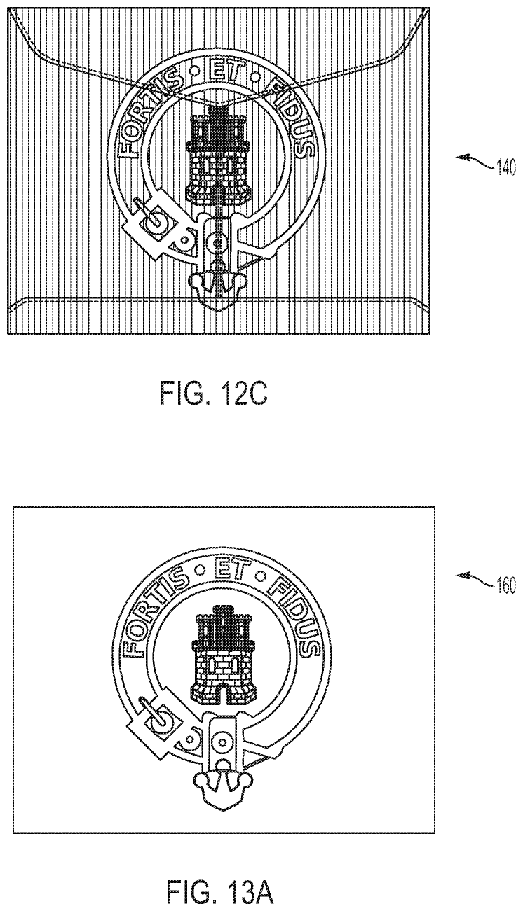

In an alternative embodiment for printing portfolio 140, and with reference to FIGS. 12A-12C, art template 130 (shown in FIG. 11A) may be printed onto side 142 of portfolio 140 using the methods of the invention described herein while flap 141 is in an open position and not printed, such as shown in FIG. 12A. As described above, the printing may be completed in a single pass and print over seam 143, raised seam 144, and stitching 145 without substantial or any distortion. Subsequently, flap 141 of portfolio 140 may be positioned and printed using methods of the invention with art template 151 having design 132′ and background color (shown as cross-hatching) as shown in FIG. 12B (including the cross-hatching as a background color). As a result, portfolio 140 may be continuously printed without distortion such that the design element is shown when the flap is in either the open or the closed position as shown in FIGS. 12A and 12C.

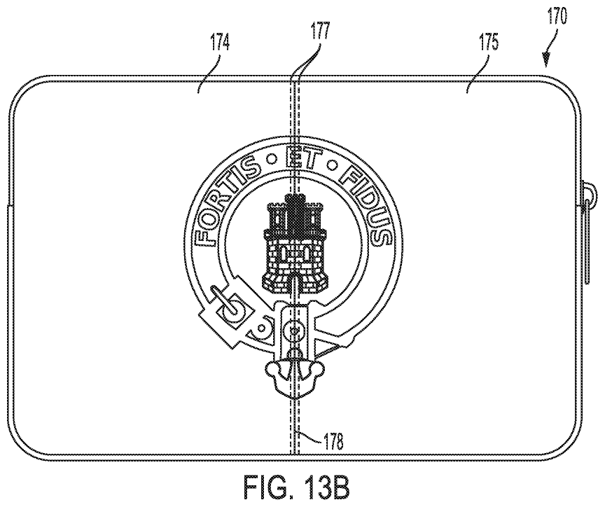

In another exemplary embodiment shown in FIG. 13B, zippered portfolio 170 is a preconstructed leather good having panels 174 and 176, stitchings 177, and seam 178. As shown in FIG. 13B, art template 160, shown in FIG. 13A, has been printed onto zippered portfolio 170 using the inventive method described herein and wherein the design is continuously printed across panels 174 and 176, stitchings 177, and seam 178 without interruption or distortion. For printing, the opposite side of zippered portfolio 170 may be separately printed in the same manner (with the same or a different art template), or the portfolio may be opened and arranged in a flat configuration such that both sides are printed in a single pass, in either scenario using the printing methods described herein. In an alternative embodiment, zippered portfolio 170 may be printed so as to have a background color or design extending across all or a portion it. In still other embodiments, a photograph, or a collage of multiple photographs, could be used as an art template and printed continuously and without distortion onto zippered portfolio 170. In still further embodiments, a photograph could be printed with additional text, graphics, or designs included in the art template. FIG. 11C shows an interior 133 of portfolio 130, which is shown as having been printed with an art template (not shown). As shown, the interior 133 has been printed continuously across multiple layered panels of leather without distortion.

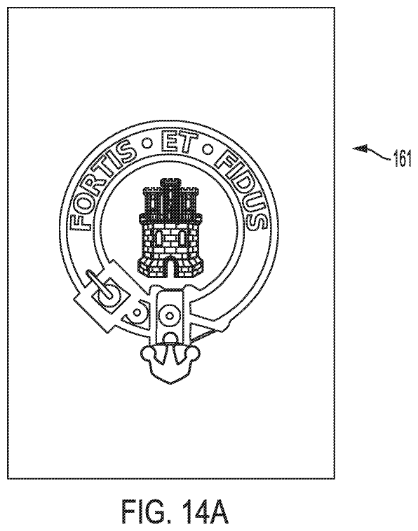

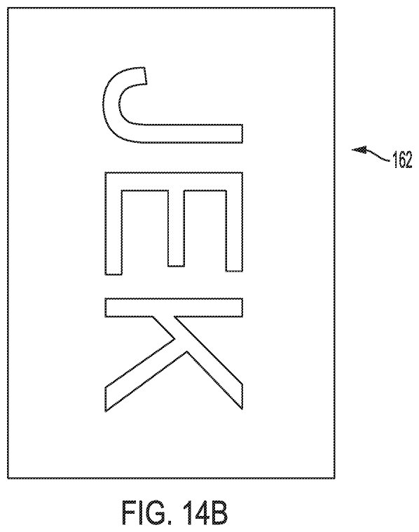

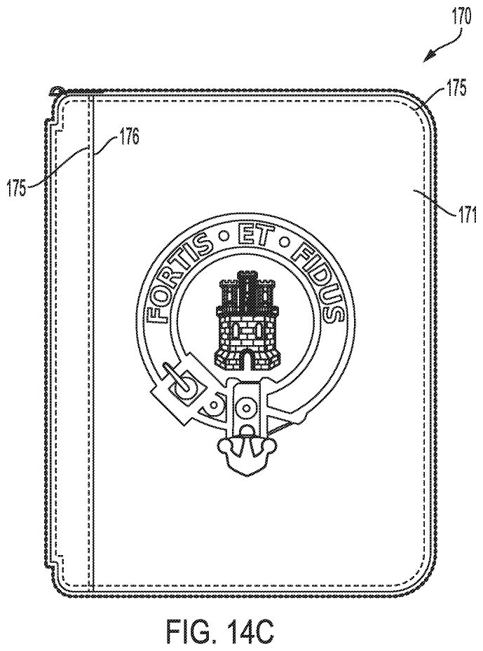

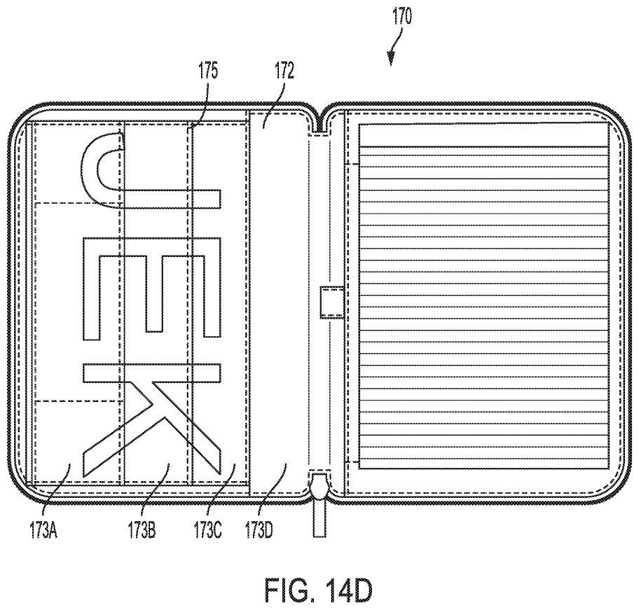

In yet another exemplary embodiment, art templates 161 and 162, as shown in FIGS. 14A and 14B, respectively, may be printed onto preconstructed leather portfolio 170, which has a first side 171, a second side (not shown), and an interior side 172 as shown in FIGS. 14C and 14D. As shown, portfolio 170 has been printed on first side 171 with art template 161 and on interior side 172 with art template 162 using the inventive methods described herein. In particular, either of first side 171 or interior side 172 may be printed and then the other subsequently printed. As shown, the printing is continuous and without distortion across stitching 175 and seam 176 on first side 171 and across distinct and uneven leather layers 173A, 173B, 173C, and 173D and stitching 175.

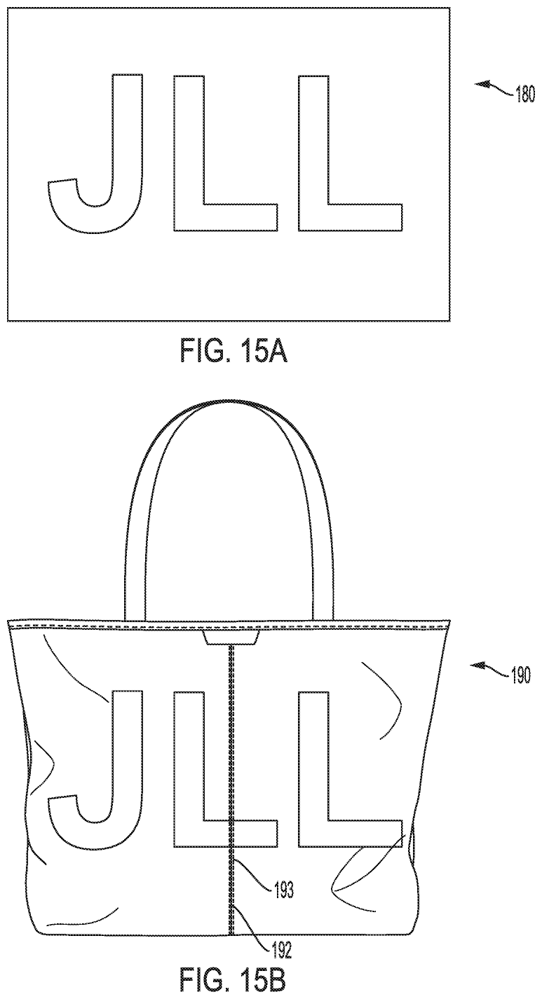

In still another exemplary embodiment, printing processes of the present invention may be employed on a leather bag 180 as a preconstructed leather good as shown in FIG. 15B. As shown, leather bag 180 includes seam 192 and stitching 193. Art template 180, shown in FIG. 15A, has been continuously printed in a single pass using methods of the present invention. Such printing includes continuously extends over and across seam 192 and stitching 193 without distortion. Other designs, text, photographs, background colors or designs, or other indicia could be printed in other embodiments by using a suitable art template. For example, textures may be printed on a preconstructed leather good by designing an art template to replicate the pattern of a texture, and printing in multiple passes may optionally be employed to provide different layers of ink to provide physical textures by way of varied ink layers in the printed preconstructed leather good.

The printing processes of the present invention may be utilized upon any preconstructed leather good. By way of example, and without limitation, such preconstructed white leather good may include belts, wallets, phone cases, key chains, book covers, portfolios, luggage tags, luggage, briefcases, bracelets, jewelry, clothing, and ornamental decorations.

It will be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its certain embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method for printing upon a preconstructed leather good comprising:
providing a preconstructed leather good comprising at least a first leather panel and a second leather panel that are adjacent or adjoining, and printing an art template across a junction of the first leather panel and the second leather panel.

2. The method of claim 1 wherein the preconstructed leather good is a finished leather good.

3. The method of claim 1 wherein the preconstructed leather good is a semi-finished leather good.

4. The method of claim 1 wherein the printing comprises printing with an ultraviolet printer.

5. The method of claim 1 wherein the first leather panel and the second leather panel are of differing sizes, shapes, or sizes and shapes.

6. The method of claim 1 wherein the adjacent or adjoining panels of the preconstructed leather good are affixed together by one or more of a seam, stitching, and adhesive.

7. The method of claim 1 wherein the first leather panel and the second leather panel are at least partially configured in different layers at the junction.

8. The method of claim 1 wherein the junction comprises a seam.

9. The method of claim 1 wherein the junction comprises stitching.

10. The method of claim 1 wherein the preconstructed leather good is comprised of white leather.

11. The method of claim 1 wherein the first leather panel and the second leather panel of the preconstructed leather good have been pretreated through one or more of chemical bathing, etching, bleaching, sand blasting, abrading, weathering, gritting, and sanding.

12. The method of claim 1 comprising treating the first leather panel and the second leather panel of the preconstructed leather good after printing with one or more of reprinting, waxing, polishing, and cleaning with a chemical agent.

13. The method of claim 1 wherein the preconstructed leather good is selected from the group consisting of a belt, wallet, credit card holder, phone case, tablet case, key chain, book cover, portfolio, luggage tag, luggage, briefcase, bracelet, jewelry, clothing, or ornamental decoration.

14. The method of claim 1 further comprising designing the art template to account for features of the preconstructed leather good to be printed.

15. The method of claim 1 wherein said art template includes one or more of text, textures, graphics, colors, and photographic images.

16. The method of claim 1 wherein said art template is designed to be the same size and shape as the preconstructed leather good to be printed.

17. The method of claim 14 further comprising aligning the preconstructed leather good in an opening of a jig, wherein the opening is approximately the same size and shape as the art template and the same size and shape as the preconstructed leather good as it is positioned in the jig.

18. The method of claim 15 further comprising securing the jig and the preconstructed leather good using one or more of a suction table, tape, or clamp, wherein the jig and the preconstructed leather good maintain their alignment throughout the printing process.

19. A method for printing upon a preconstructed leather good comprising:
providing a preconstructed leather good comprising at least a first leather panel and a second leather panel that are adjacent or adjoining, and printing an art template across a junction of the first leather panel and the second leather panel.
wherein the adjacent or adjoining panels of the preconstructed leather good are affixed together by one or more of a seam, stitching, and adhesive,
wherein said art template includes one or more of text, textures, graphics, colors, and photographic images, and
wherein the printing comprises printing with an ultraviolet printer.

20. The method of claim 19 further comprising aligning the preconstructed leather good in an opening of a jig, wherein the opening is approximately the same size and shape as the art template and the same size and shape as the preconstructed leather good as it is positioned in the jig.
